(19) United States
(12) Patent Application Publication
(10) Pub. No.: US 2026/0194110 A1
(43) Pub. Date: Jul. 9, 2026

(54) DRIVELINE AXLE CONNECTION WITH RADIAL DIRECTION FACE SPLINE WITHOUT RETENTION CHECK

(71) Applicant: GM GLOBAL TECHNOLOGY OPERATIONS LLC, Detroit, MI (US)

(72) Inventors: Minseung Kim, Seocho-gu (KR); Youngmin Seo, Seoul (KR)

(73) Assignee: GM GLOBAL TECHNOLOGY OPERATIONS LLC, Detroit, MI (US)

(21) Appl. No.: 19/014,744

(22) Filed: Jan. 9, 2025

(51) Int. Cl. F16D 1/033

(52) U.S. Cl. CPC F16D 1/033; F16D 2250/0084; F16D 2300/10; F16D 2300/12

(57) ABSTRACT

Disclosed is a first vehicle torque shaft to a second vehicle torque shaft connection utilizing a lock nut and a method assembling the same.

### INTRODUCTION

The technical field generally relates to vehicle drivelines, components thereof, and methods of assembling the same.

Heretofore, the connection between the half shaft and the drivetrain or front/rear axle of a vehicle was commonly achieved through a plug-in design. This design features axial splines, with both ends of the shaft secured by internal circlips within the splines. As a result, during vehicle assembly, operators need to perform a retention inspection to ensure that the snap rings are properly seated in the grooves to prevent the half shaft from disengaging.

Accordingly, it is desirable to provide a design for the shaft connection that is a visually intuitive design that allows operators to easily assemble it and eliminates the need for a retention inspection. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including: a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines.

A number of variations may include a product wherein the first end face further including a first mating feature.

A number of variations may include a product wherein the first vehicle torque shaft includes a first portion and an adjacent second portion tapering outwardly from the first portion.

A number of variations may include a product wherein the adjacent second portion includes an outwardly extending rib.

A number of variations may include a product further including a lock nut constructed and arranged to lock to the first vehicle torque shaft.

A number of variations may include a product further including a lock nut having a first protrusion extending from a bottom face of the lock nut wherein the first protrusion is constructed and arranged to lock against the outwardly extending rib, the lock nut having a through hole formed therein.

A number of variations may include a product further including a second vehicle torque shaft including a first spiral fastening thread on an outer surface near a second end face.

A number of variations may include a product wherein the lock nut includes a second spiral fastening thread for mating with the first spiral fastening thread.

A number of variations may include a product wherein the second end face including a second plurality of spaced apart radially extending splines and a second plurality of spaced apart radially extending troughs, wherein one of the second plurality of spaced apart radially extending troughs is between the two adjacent splines of the second plurality of spaced apart radially extending splines, and wherein the first end face comprises a first mating feature and the second end face comprises a second mating feature constructed and arranged to auto-align with the first mating feature.

A number of variations may include a product wherein the first portion of the second vehicle torque shaft extends through the through hole in the lock nut and wherein the second spiral fastening thread of the second vehicle torque shaft is mated to the first spiral fastening thread of the first vehicle torque shaft, the first plurality of spaced apart radially extending splines are received in the second plurality of spaced apart radially extending troughs and the second plurality of spaced apart radially extending splines are received in the first plurality of spaced apart radially extending troughs, and wherein the first protrusion is locked against the outwardly extending rib.

A number of variations may include a method including: providing a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines.

A number of variations may include a method wherein the first end face further including a first mating feature.

A number of variations may include a method wherein the first vehicle torque shaft includes a first portion and an adjacent second portion tapering outwardly from the first portion.

A number of variations may include a method wherein the adjacent second portion includes an outwardly extending rib.

A number of variations may include a method further including providing a lock nut constructed and arranged to lock to the first vehicle torque shaft, and inserting the first portion through a through hole formed in the lock nut.

A number of variations may include a method wherein the lock nut includes a first protrusion extending from a bottom face of the lock nut wherein the first protrusion is constructed and arranged to lock against the outwardly extending rib.

A number of variations may include a method further including providing a second vehicle torque shaft including a first spiral fastening thread on an outer surface near the first end face, the lock nut including a second spiral fastening thread for mating with the first spiral fastening thread.

A number of variations may include a method wherein the second vehicle torque shaft includes a second end face including a second plurality of spaced apart radially extending splines and a second plurality of spaced apart radially extending troughs, wherein one of the second plurality of spaced apart radially extending troughs is between two adjacent splines of the second plurality of spaced apart radially extending splines, and wherein the first end face comprises a first mating feature and the second end face comprises a second mating feature constructed and arranged to auto-align with the first mating feature.

A number of variations may include a method wherein the second end face includes a second plurality of spaced apart radially extending splines and a second plurality of spaced apart radially extending troughs, wherein one of the second plurality of spaced apart radially extending troughs is between two adjacent splines of the second plurality of spaced apart radially extending splines, and rotating the lock nut so that the second spiral fastening thread engages the first spiral fastening thread so that the lock nut moves along the first vehicle torque shaft so that the first protrusion slides over and locks against the outwardly extending rib preventing the lock nut from becoming unintentionally loosened.

A number of variations may include a system including: a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines, wherein the first end face further including a first mating feature, a first spiral fastening thread on an outer surface near the first end face; a second vehicle torque shaft having a first portion and an adjacent second portion tapering outwardly from the first portion, the adjacent second portion includes an outwardly extending rib, the second vehicle torque shaft having a the second end face including a second plurality of spaced apart radially extending splines and a second plurality of spaced apart radially extending troughs, wherein one of the second plurality of spaced apart radially extending troughs is between two adjacent splines of the second plurality of spaced apart radially extending splines; a lock nut including a first projection extending from a bottom face of the lock nut wherein the first projection is constructed and arranged to lock against the outwardly extending rib, the lock nut including a second spiral fastening thread for mating with the first spiral fastening thread; wherein the second end face comprises a second mating feature constructed and arranged to auto-align with the first mating feature; wherein the second end face comprises a second mating feature constructed and arranged to auto-align with the first mating feature; wherein the first portion of the second vehicle torque shaft is extendable through a through hole in the lock nut, and the lock nut being rotatable so that the second spiral fastening thread mates with the first spiral fastening thread, the lock nut being rotatable to move along the second vehicle torque shaft so that the first projection slides over and locks against the outwardly extending rib.

### BRIEF DESCRIPTION OF THE DRAWINGS

The illustrative variations will hereinafter be described in conjunction with the following drawing figures, wherein like numerals denote like elements, and wherein:

FIG. 1 is a schematic illustration of a portion of the vehicle including an axial connection from a powertrain to a driveline to transmit power to the wheels of the vehicle according to a number of variations;

FIG. 2 is a partial, exploded view of FIG. 1 according to a number of variations;

FIG. 3 is a partial, exploded, perspective view of a first vehicle torque shaft to a second vehicle torque shaft connection utilizing a lock nut according to a number of variations;

FIG. 4 is a partial, exploded, perspective view of a first vehicle torque shaft to a second vehicle torque shaft connection utilizing a lock nut according to a number of variations;

FIG. 5 is an enlarged, partial view of an assembled a first vehicle torque shaft to a second vehicle torque shaft connection utilizing a lock nut according to a number of variations;

FIG. 6 is a partial, sectional view of a first vehicle torque shaft to a second vehicle torque shaft connection utilizing a lock nut according to a number of variations;

FIG. 7 is an enlarged, partial view with portions broken away, of a first vehicle torque shaft to a second vehicle torque shaft connection utilizing a lock nut according to a number of variations;

FIG. 8 is a schematic illustration of a vehicle including a first vehicle torque shaft to a second vehicle torque shaft connection utilizing the lock nut according to a number of variations; and

FIG. 9 is a flow diagram of a method of assembling a first vehicle torque shaft to a second vehicle torque shaft utilizing a lock nut according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

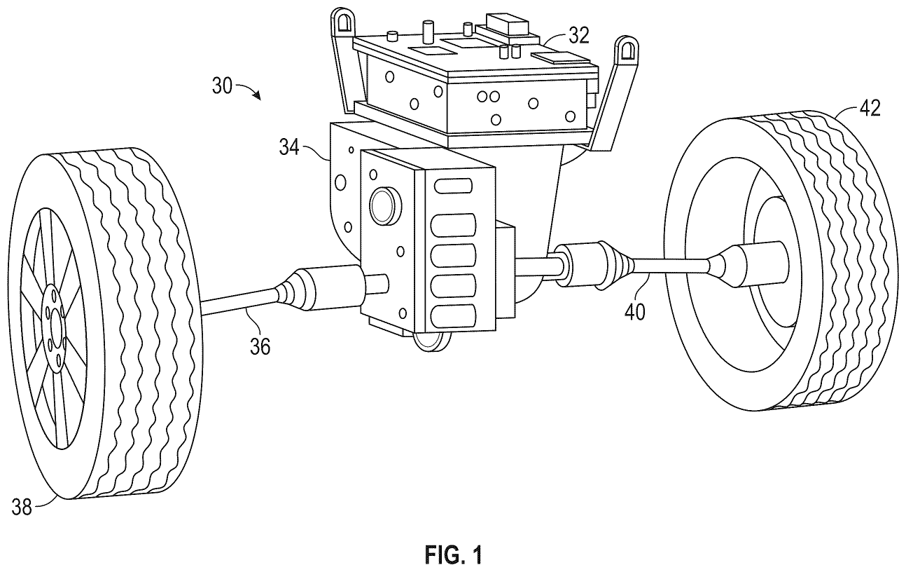

FIG. 1 is a schematic illustration of a portion of a vehicle including an axial connection from a powertrain to a driveline to transmit power to the wheels of the vehicle according to a number of variations. A number of variations may include a product 30 which may include a propulsion plant 32. The propulsion plant 32 may be a combustion engine, electric motor, fuel cell, or any other device known to those skilled in the art for propelling a vehicle. The propulsion plant 32 may be connected to a transmission 34. A first half shaft 36 may connect the transmission 34 to a first wheel assembly 38 to drive the same. Similarly, a second half shaft 40 may be connected to the transmission 34 and to a second wheel assembly to drive the same.

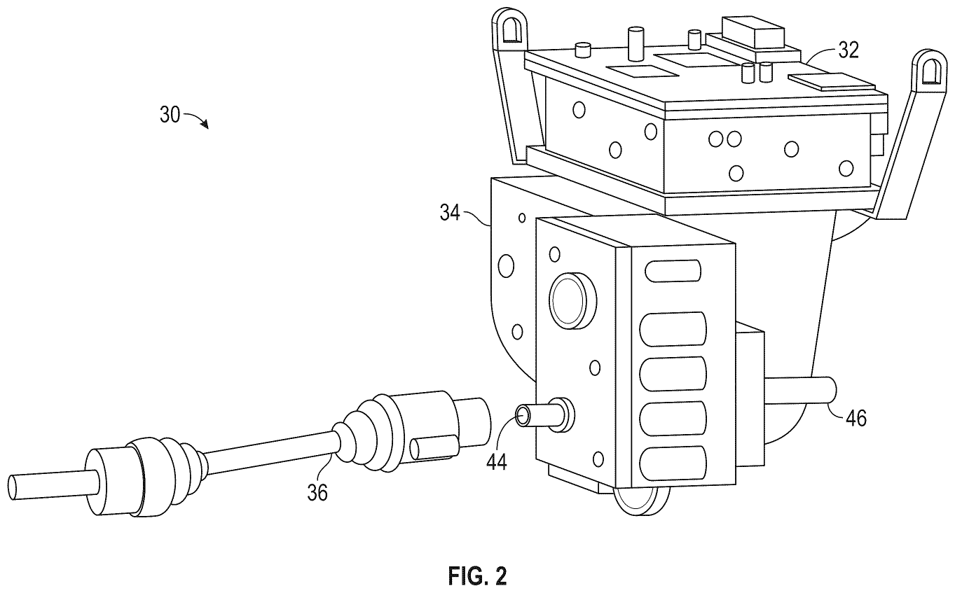

FIG. 2 is a partial, exploded view of a portion of FIG. 1 showing a first half shaft 36 positioned to be coupled to a first driveshaft extending from the transmission 34 a second driveshaft 46 extends from the transmission and the second half shaft 40 shown in FIG. 1 may be connected thereto.

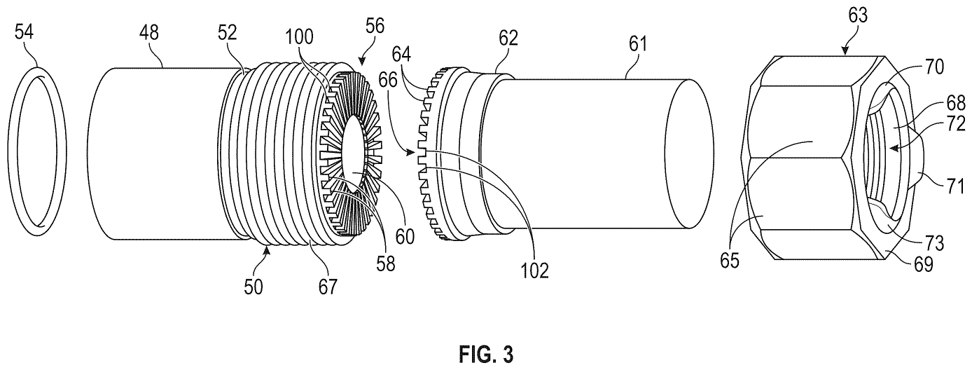

FIG. 3 is a partial, exploded, perspective view of a first vehicle torque shaft 48, a second vehicle torque shaft 61, and a lock nut 63 for connecting together the first vehicle torque shaft 48 and a second vehicle torque shaft 61 according to a number of variations. A first spiral fastening thread 50 may be formed in an outer surface of the first vehicle torque shaft 48 near a first end face 56 of the first vehicle torque shaft 48. An annular recess 52 may be formed in an outer surface of the first vehicle torque shaft 48 at a location further from the first end face 56 than the first spiral fastening thread 50. An O-ring 54 may be received in the annular recess 52 to protect the first spiral fastening thread 50 from debris and liquids when the lock nut 63 is position to connect the first vehicle torque shaft 48 and the second vehicle torque shaft 61 together. A first plurality of spaced apart radially extending splines 58 and a first plurality of spaced apart radially extending troughs 100 may be provided at the first end face 56 of the first vehicle torque shaft 48, wherein one of the plurality of spaced apart radially extending troughs 100 is provided between two adjacent spaced apart radially extending splines 58. A first mating feature 60 may be formed in the first end face 56 of the first vehicle torque shaft 48. The first mating feature 60 may be of any of a variety of shapes including, but not limited to, a convex or concave surface, or a mating projection or a mating recess. The first mating feature 60 may be centered on the first end face 56.

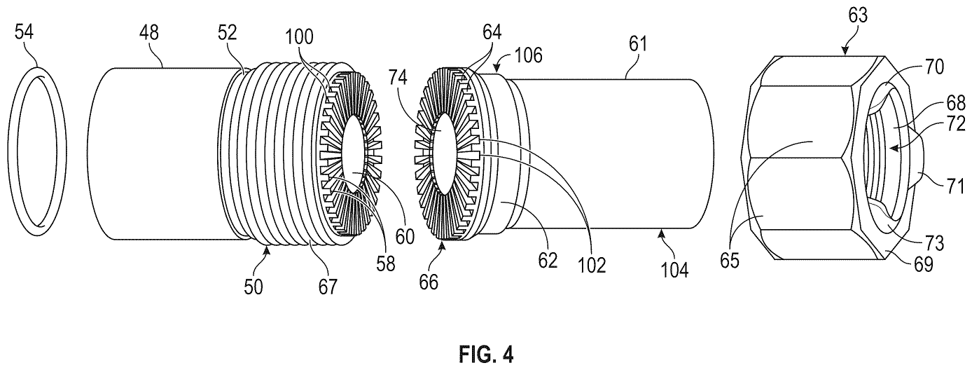

Referring to FIGS. 3-4, the second vehicle torque shaft 61 may include a first portion 104 and an adjoining outwardly tapering second portion 106 having an outwardly extending rib 62. The outwardly extending rib 62 may be in an outwardly extending annular rib. A second end face 66 of the second vehicle torque shaft 61 may have a second plurality of spaced apart radially extending splines 64 and a second plurality of spaced apart radially extending troughs 102, wherein at least one of the second plurality of spaced apart radially extending troughs 102 is provided between two adjacent spaced apart radially extending splines 64. A second mating feature 74 (best seen in FIG. 4) may be formed in the second end face 66 of the second vehicle torque shaft 61. The second mating feature 74 may be of any of a variety of shapes including, but not limited to, a convex or concave surface, or a mating projection or a mating recess. The first mating feature 60 and the second mating feature 74 may be mated together when the first vehicle torque shaft 48 and the second vehicle torque shaft 61 are connected together. The second mating feature may be centered on the second end face 66. The second mating feature 74 may be centered on the second end face 66. In a number of variations, the first mating feature 60 and the second mating feature 74 may be constructed and arrange to auto-align the first end face and second end face when the when the first vehicle torque shaft 48 and the second vehicle torque shaft 61 are being connected together. For example, but not limited to, one of the first mating feature 60 or the second mating feature 74 may have a concave surface and the other of the first mating feature 60 or the second mating feature 74 may have a convex surface.

A lock nut 63 may be provided and may have a plurality of flats 65 on an outer surface thereof to be used to tighten the lock nut 63, for example, with a wrench. The lock nut 63 may have a through hole 72 formed therein and at least partially defined by a second spiral fastening thread 68 constructed and arranged to mate with the first spiral fastening thread 67. The lock nut 63 may include a first protrusion 70, a second protrusion 71, a third protrusion 73 each extending in an axial direction from a bottom surface 69 of the lock nut 63. The first protrusion 70 may be positioned at one hundred twenty degrees (120°) from the second protrusion 71. The third protrusion 73 may be positioned at 120° from the second protrusion 71. Each of the first protrusion 70, the second protrusion 71, and the third protrusion 73 may be constructed and arranged to be sufficiently flexible to slide over and lock against the outwardly extending rib 62 of the second vehicle torque shaft 61.

Referring to FIGS. 3-5, in a number of variations, the first vehicle torque shaft 48 and the second vehicle torque shaft 61 may be connected together by inserting the first plurality of spaced apart radially extending splines 58 into the second plurality of spaced apart radially extending troughs 102 and so that the second plurality of spaced apart radially extending splines 64 are received in the first plurality of spaced apart radially extending troughs 100, and so that the first mating feature 60 and the second mating feature 74 are mated together. The first portion 104 of the second vehicle torque shaft 61 may be inserted through the through hole 72 of the lock nut 63. The lock nut 63 may be rotated so that the second spiral fastening thread 68 of the lock nut 63 mates with the first spiral fastening thread 67 of the first vehicle torque shaft 48. The lock nut 63 may be rotated in a first direction, for example clockwise, so that the first protrusion 70, second protrusion 71 and third protrusion 73 slide over the outwardly extending rib 62 of the second vehicle torque shaft 61 and so that each of the first protrusion 70, second protrusion 71 and third protrusion 73 lock against the outwardly extending rib 62 to prevent the lock nut 63 from being unintentionally loosened by, for example, vibration while a vehicle is in operation. The first protrusion 70, second protrusion 71, and third protrusion 73 are each sufficiently flexible so that the lock nut 63 may be intentionally removed a person or machine by rotating the lock nut in a second direction opposite the first direction with sufficient force so that each of the first protrusion 70, second protrusion 71, and third protrusion 73 slide past the outwardly extending rib 62.

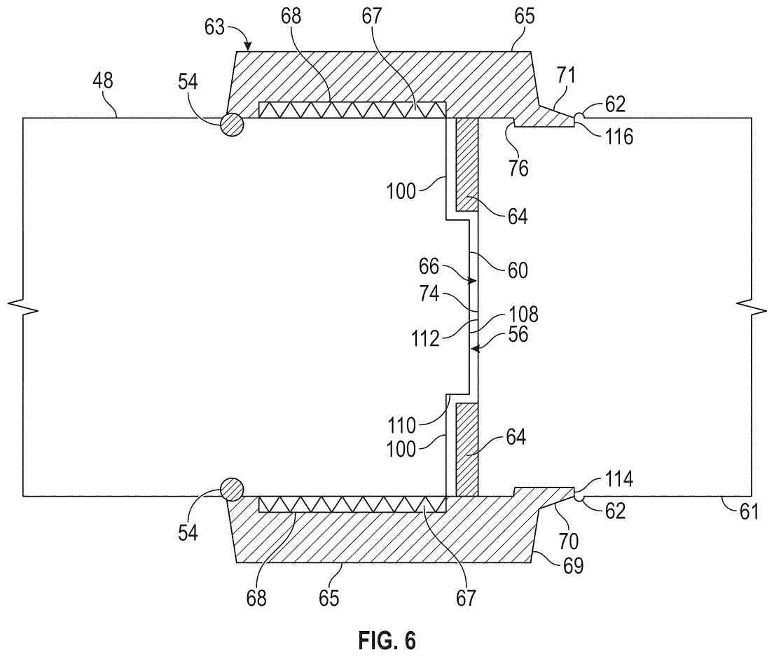

Referring to FIG. 6, the first vehicle torque shaft 48 may have a first end face 56 that may include a first mating feature 60 that may be a mating projection having a first flat face 108 and a side wall 110. The second vehicle torque shaft 61 may include a second mating feature 74 which may be a mating recess having a second flat face 112 for engagement with the first flat face 108 of the first end face 56 of the first vehicle torque shaft 48. The second vehicle torque shaft 61 may have a plurality of spaced apart radially extending splines 64, wherein one of the plurality of spaced apart radially extending splines 64 is received in one of the plurality of spaced apart radially extending troughs 100 formed in the first end face 56 of the first vehicle torque shaft 48. Alternatively, the first mating feature 60 may be a mating projection and the second mating feature 74 may be a mating recess. Still further, the first mating feature 60 may have a concave surface for mating with a convex surface of the second mating feature 74. The lock nut 63 may include a step 76 which partially defines the through hole 72.

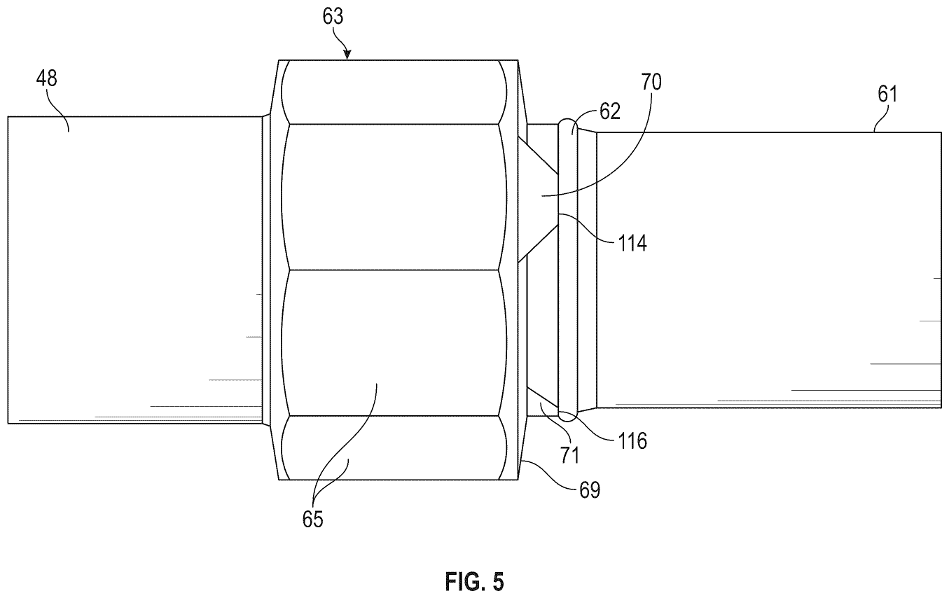

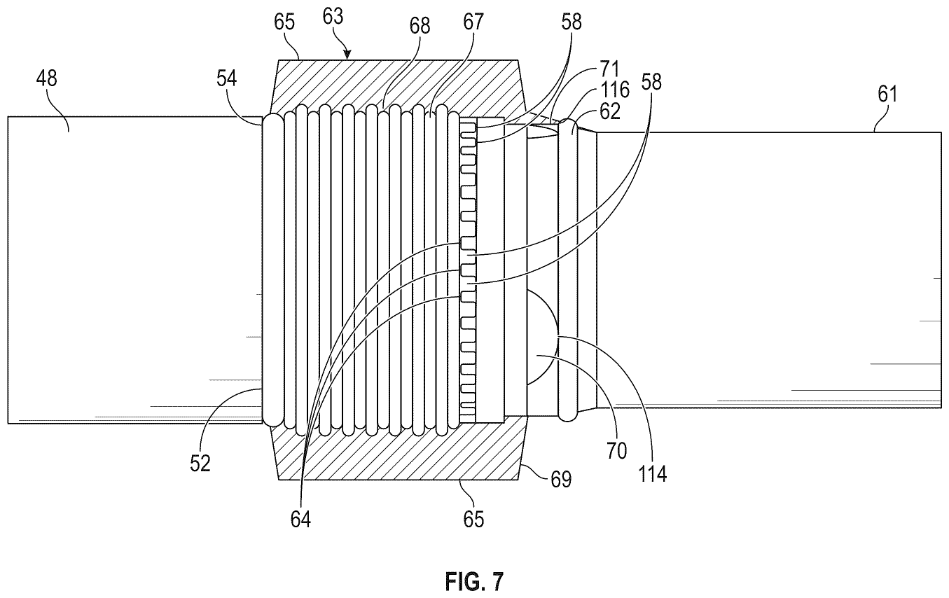

Referring to FIGS. 5-7, when the lock nut 63 is in a locked position a first end surface 114 of the first protrusion 70 may engage the outwardly extending rib 62. Similarly, when the lock nut 63 is in a locked position a second end surface 116 of the second protrusion 71 may engage the outwardly extending rib 62.

FIGS. 3-7 illustrate a system of component working together including first vehicle torque shaft 48, a second vehicle torque shaft 61, and a lock nut 63 for connecting together the first vehicle torque shaft 48 and a second vehicle torque shaft 61 according to a number of variations.

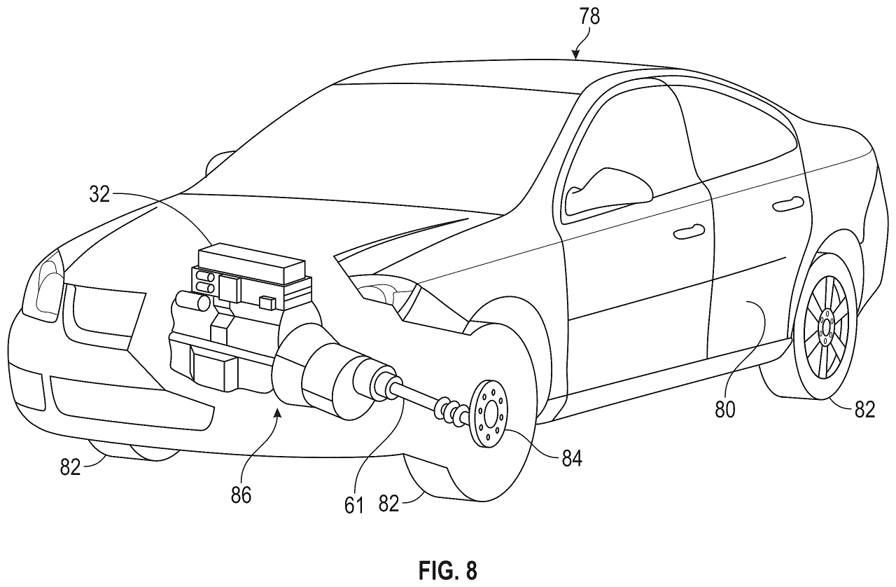

FIG. 8 is a schematic illustration of a vehicle having a second vehicle torque shaft 61 that may be connected to transaxle 86 using a lock nut in a manner as described herein. The transaxle 86 may be connected to a propulsion plant 32, which may be a combustion engine or other vehicle propulsion plant.

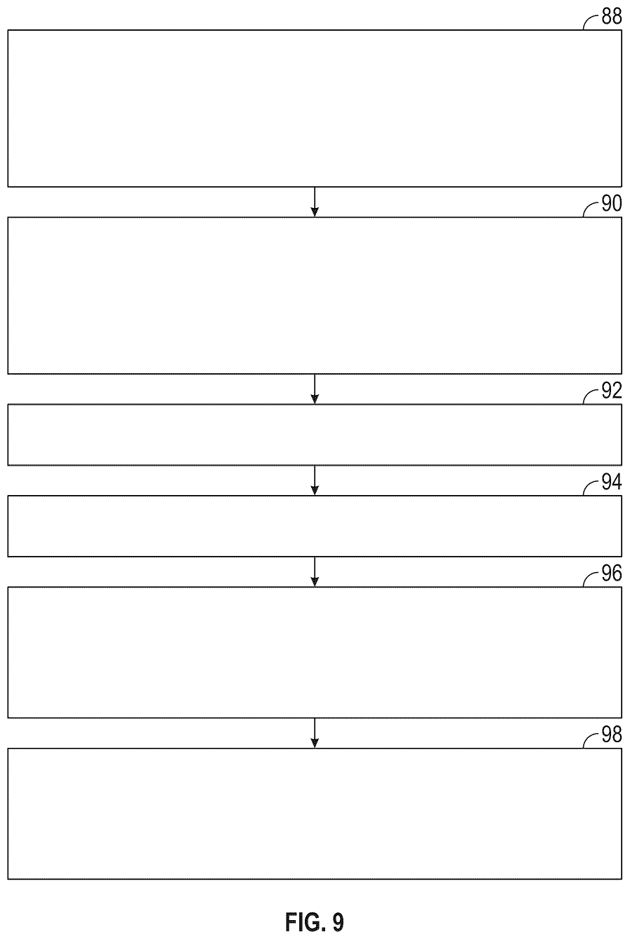

Referring to FIG. 9, a number of variations may include a method including a first act 88 of providing a vehicle torque shaft including a first end face including a first plurality of spaced apart radially extending splines defined at least in part by a first plurality of spaced apart troughs in the first end face, wherein the first end face includes a first mating feature, and wherein the first vehicle torque shaft includes a first spiral fastening thread near the first end face. A second act 90 may include providing a second vehicle torque shaft including a first end face including a second plurality of spaced apart radially extending splines defined at least in part by a second plurality of spaced apart troughs formed in the second end face, wherein the second end face includes a second mating feature configured to mate with the first mating feature. A third act 92 may include providing a lock nut having a through hole defined at least in part by a second spiral fastening thread. A fourth act 94 may include inserting the first vehicle torque shaft into the through hole formed in the lock nut. The fifth act 96 may include mating the first plurality of spaced apart radially extending splines with the second plurality of spaced apart radially extending troughs in the second face, mating the second plurality of spaced apart radially extending splines with the first plurality of spaced apart trough. A sixth act 98 may include rotating the lock nut so that the second spiral fastening thread engages the first spiral fastening thread and rotating the lock nut so that the lock nut moves along the first vehicle torque shaft until the lock nut is in a locked position on the second vehicle torque shaft preventing the lock nut from becoming unintentionally loosened.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines.

2. The product as set forth in claim 1 wherein the first end face further comprising a first mating feature.

3. The product as set forth in claim 1 wherein the first vehicle torque shaft includes a first portion and an adjacent second portion tapering outwardly from the first portion.

4. The product as set forth in claim 3 wherein the adjacent second portion includes an outwardly extending rib.

5. The product as set forth in claim 1 further comprising a lock nut constructed and arranged to lock to the first vehicle torque shaft.

6. The product as set forth in claim 4 further comprising a lock nut having a first protrusion extending from a bottom face of the lock nut wherein the first protrusion is constructed and arranged to lock against the outwardly extending rib, the lock nut having a through hole formed therein.

7. The product as set forth in claim 6 further comprising a second vehicle torque shaft including a first spiral fastening thread on an outer surface near a second end face.

8. The product as set forth in claim 7 wherein the lock nut includes a second spiral fastening thread for mating with the first spiral fastening thread.

9. The product is set forth in claim 8 wherein the second end face including a second plurality of spaced apart radially extending splines and a second plurality of spaced apart radially extending troughs, wherein one of the second plurality of spaced apart radially extending troughs is between the two adjacent splines of the second plurality of spaced apart radially extending splines, and wherein the first end face comprises a first mating feature and the second end face comprises a second mating feature constructed and arranged to auto-align with the first mating feature.

10. The product of claim 9 wherein the first portion of the second vehicle torque shaft extends through the through hole in the lock nut and wherein the second spiral fastening thread of the second vehicle torque shaft is mated to the first spiral fastening thread of the first vehicle torque shaft, the first plurality of spaced apart radially extending splines are received in the second plurality of spaced apart radially extending troughs and the second plurality of spaced apart radially extending splines are received in the first plurality of spaced apart radially extending troughs, and wherein the first protrusion is locked against the outwardly extending rib.

11. A method comprising:
providing a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines.

12. The method as set forth in claim 11 wherein the first end face further comprising a first mating feature.

13. The method as set forth in claim 11 wherein the first vehicle torque shaft includes a first portion and an adjacent second portion tapering outwardly from the first portion.

14. The method as set forth in claim 13 wherein the adjacent second portion includes an outwardly extending rib.

15. The method as set forth in claim 14 further comprising providing a lock nut constructed and arranged to lock to the first vehicle torque shaft, and inserting the first portion through a through hole formed in the lock nut.

16. The method as set forth in claim 15 wherein the lock nut includes a first protrusion extending from a bottom face of the lock nut wherein the first protrusion is constructed and arranged to lock against the outwardly extending rib.

17. The method as set forth in claim 16 further comprising providing a second vehicle torque shaft including a first spiral fastening thread on an outer surface near the first end face, the lock nut including a second spiral fastening thread for mating with the first spiral fastening thread.

18. The method as set forth in claim 17 wherein the second vehicle torque shaft includes a second end face including a second plurality of spaced apart radially extending splines and a second plurality of spaced apart radially extending troughs, wherein one of the second plurality of spaced apart radially extending troughs is between two adjacent splines of the second plurality of spaced apart radially extending splines, and wherein the first end face comprises a first mating feature and the second end face comprises a second mating feature constructed and arranged to auto-align with the first mating feature.

19. The method is set forth in claim 18 wherein the second end face includes a second plurality of spaced apart radially extending splines and a second plurality of spaced apart radially extending troughs, wherein one of the second plurality of spaced apart radially extending troughs is between two adjacent splines of the second plurality of spaced apart radially extending splines, and rotating the lock nut so that the second spiral fastening thread engages the first spiral fastening thread so that the lock nut moves along the first vehicle torque shaft so that the first protrusion slides over and locks against the outwardly extending rib preventing the lock nut from becoming unintentionally loosened.

20. A system comprising:
a first vehicle torque shaft having a first end face including a first plurality of spaced apart radially extending splines and a first plurality of spaced apart radially extending troughs, wherein one of the first plurality of spaced apart radially extending troughs is between two adjacent splines of the first plurality of spaced apart radially extending splines, wherein the first end face further comprising a first mating feature, a first spiral fastening thread on an outer surface near the first end face;
a second vehicle torque shaft having a first portion and an adjacent second portion tapering outwardly from the first portion, the adjacent second portion includes an outwardly extending rib, the second vehicle torque shaft having a the second end face including a second plurality of spaced apart radially extending splines and a second plurality of spaced apart radially extending troughs, wherein one of the second plurality of spaced apart radially extending troughs is between two adjacent splines of the second plurality of spaced apart radially extending splines;
a lock nut including a first projection extending from a bottom face of the lock nut wherein the first projection is constructed and arranged to lock against the outwardly extending rib, the lock nut including a second spiral fastening thread for mating with the first spiral fastening thread;
wherein the second end face comprises a second mating feature constructed and arranged to auto-align with the first mating feature;
wherein the first portion of the second vehicle torque shaft is extendable through a through hole in the lock nut, and the lock nut being rotatable so that the second spiral fastening thread mates with the first spiral fastening thread, the lock nut being rotatable to move along the second vehicle torque shaft so that the first projection slides over and locks against the outwardly extending rib.
